(19) United States
(12) Patent Application Publication
(10) Pub. No.: US 2012/0067969 A1
(43) Pub. Date: Mar. 22, 2012

(54) Method and apparatus for irrigation water acidification delivery

(75) Inventor: Terry Gong, Moraga, CA (US)

(73) Assignee: Harmon Systems International, LLC, Bakersfield, CA (US)

(21) Appl. No.: 12/924,101

(22) Filed: Sep. 21, 2010

(51) Int. Cl. A01G 25/09; A01C 23/00

(52) U.S. Cl. 239/10; 239/728; 239/413

(57) ABSTRACT

An apparatus for acidifying and applying irrigation water to a field of ground to be irrigated comprising a fixed or traveling conveyance structure with a water delivery system associated with a plurality of independently operable sprinkler assemblies associated with mixing valves, the water delivery system, and a sulfurous acid manifold to mix acidified water with the water delivered to the sprinkler assemblies to distribute co-mixed acidified water over the ground.

### BACKGROUND OF THE INVENTION

1. Field

This invention generally relates to irrigation apparatus and methods for acidified water application, and more particularly to adapter kits for irrigation machinery to apply sulfurous acid in the field.

2. State of the Art

McCann et al., U.S. Pat. No. 5,246,164 issued Sep. 21, 1993 is a method and apparatus for variable application of irrigation water and chemicals using a controller to adjust the delivery of irrigation water through various types of sprinkler irrigation equipment to various soil zones. McCann et al describes various types of sprinkler irrigation equipment for delivering water mixed with fertilizers, pesticides and other soil amendments.

“Some of the irrigation equipment in common use today can generally be categorized as follows: continuously moving systems, such as center pivot systems, linear line systems, solid set sprinkler line, and wheel lines.

The center pivot system usually embodies a buried main supply line through which irrigation water is pumped, under pressure, to a fixed central pivot tower and up through some sort of a sealed rotatable coupling to a horizontal sprinkler header line which extends radially out from the center pivot assembly. The horizontally oriented sprinkler header line is supported by a plurality of movable support towers, such that the header line can be rotated about the center pivot tower. A plurality of sprinkler assemblies are connected to outlets at spaced intervals along the main line, thus forming a fixed array which is movable. When the main irrigation water supply line and irrigation line are pressurized with a supply of irrigation water, the sprinklers operate automatically to sprinkle the water out over zones of the field located beneath the sprinklers. There are two types of sprinklers in common use today, the first is the impact sprinkler which requires a relatively high pressure supply of water and a spring-loaded rocker baffle, which repeatedly impinges upon the flow of water from the sprinkler nozzle to break it into droplets, with the momentum of the baffle impacts being used to rotate the sprinkler head about a central axis. The second type of sprinkler assembly uses passive baffle plates, wherein a stream of water is discharged through a nozzle and impinges upon a fixed or rotating distribution baffle which disperses the water over the zonal surface area below the pivot irrigation line.

While pivot irrigation systems can be sized to irrigate a circular or arcuate section of a field of virtually any size, typically they are sized to irrigate fields of approximately 160 acres. These are one-half mile in length and are commonly called quarter sections, and utilize ten to fifteen movable towers supporting a main sprinkler header having between 100 and 150 sprinkler assemblies. By its inherent design, the ground speed of the sprinkler header line increases the farther away from the center point, and as a result the nozzles through which the water passes from the main header to the sprinkler assemblies are sized to deliver the least flow rate of water close to the center pivot assembly, and the most water at the farthest point along the main header, so that the radial distribution of water along the line from the center pivot assembly to the outermost nozzle is uniform.

McCann et al., continues, “The total amount of water, delivered by the distribution system across the field, is determined by the rate of rotation of the pivot towers. Commonly, each of the movable towers is supported by two to four wheels, at least one of which is driven by an electrical or hydraulic motor using some sort of a gear reduction system to synchronize the speeds of the towers, with the outermost towers traveling fastest, and the innermost the slowest. While it is possible to provide variable speed motors to adjust the angular rotation rate of the tower assemblies to either increase or decrease the speed at which the tower assemblies rotate, in practice the preferred commercial method of achieving this goal is to operate or move the tower assemblies intermittently from angular position to position around the field. Typically this is accomplished by use of an electrical control system which turns on and off the electrical motor of the outermost tower to rotate this tower. The electrical motors of the intermediate towers are controlled by a set of electromechanical switches which turn on and off to keep the intermediate towers in alignment with the outermost tower as it travels around the field. Power to each of the tower motors is provided by means of a common line strung parallel to the sprinkler header and energized through a slip ring assembly at the pivot center tower. If the center pivot assembly is to operate at maximum speed, the electrical power system for the outermost tower is on at all times, and to operate at half speed, a 50% cycle would be utilized wherein the electrical motor at the outermost tower is energized 50% of the time, for example, 30 seconds out of every 60 seconds, thus causing the pivot assembly to move at intermittent intervals, resulting in an average rotation of half of full speed.

The second common type of continuously moving self-propelled system is the linear move system, wherein a main irrigation water supply line is positioned along one side of the field, and a sprinkler header, supported at spaced intervals by movable towers and/or wheels extends out normal to the main irrigation line and transverse across the field. As with the center pivot irrigation system, a plurality of sprinkler assemblies are provided at spaced intervals along the sprinkler header. Hydraulic connection between the main irrigation supply system and the sprinkler header is commonly provided by means of a suction pipe in a canal, or a flexible connecting line which connects the inlet of the sprinkler header to any one of a plurality of main line connectors which are spaced at intervals along the main supply line. The transverse sprinkler and sprinkler header assembly, with the sprinklers in a line abreast formation, is then linearly advanced across the field while being supplied with pressurized water. More technologically advanced linear systems utilize two flexible line connectors which are automatically connected to the main line discharge headers one after the other in leap-frog fashion.

The third irrigation system relevant to which the present invention is the stationary irrigation system, which is essentially a lattice grid of fixed irrigation pipe connected to a main irrigation supply line and having a plurality of spaced apart risers and sprinkler heads for distributing water over the field. In these systems, the main irrigation supply line functions as a supply manifold, with each of the fixed sprinkler header lines having a supply valve which opens and closes to supply water to its appendant sprinkler heads.

A fourth type of irrigation system is really a hybrid combination between the linear move system and the stationary, and is called the wheel line irrigation system. Like the linear move system, the wheel line irrigation system utilizes a main irrigation water supply line positioned along one side of the field and a sprinkler header, supported at spaced intervals by wheels which typically use the sprinkler header as a common axle for movement transversely across the field. Unlike the linear move system though, the wheel line is moved, usually by a gasoline engine, from one mainline connector position to the next, and then stopped and held stationary while irrigating a particular transverse zone of the field. In this aspect, the wheel line system is similar to the solid set in that the sprinklers are stationary at the time that water is being distributed across a particular zone of the field.

Each of these systems is designed for, and often times incorporates, features enabling the introduction of chemicals, be they fertilizers, pesticides or other types of agricultural chemicals, into the irrigation water being sprinkled over the field. In practice, it is quite common to introduce nitrates, nitrogen and phosphorous fertilizer, usually in the form of a liquid solution into the irrigation water as the field is being irrigated.

In all four systems, materials used for their construction are of lightweight strong construction, such as aluminum and steel, which position and support the nozzles. These systems are susceptible to acid attack. Consequently, there is a need for an adaptation of these four systems with an acid resistant delivery system, which delays the admixing of sulfurous acid with irrigation water until just before passage through sprinkler nozzles to prevent damage to the irrigation water delivery systems.

The invention described below provides such an invention.

### SUMMARY OF THE INVENTION

Irrigation water often contains dissolved contaminants such as bicarbonates/carbonates (Total Alkalinity) that in many cases should be eliminated and/or lessened to prevent buildup in the soil. Removing alkalinity from the water requires acidification. Prior art acidification methods are oriented to introduce acidity to affect the entire flow stream of irrigation water conveyed through irrigations conveyance machines, such as center pivots, linear lines, and/or linear move systems. These delivery methods make irrigation water delivery machines vulnerable to corrosion damage when improperly applied and/or misused. To avoid and eliminate this problem, a safer way to remove and eliminate bicarbonates/carbonates is needed. The objective of the invention is thus to provide an alternative way to introduce acidity into irrigation water and soil/water solutions. The invention comprises:

a. a fixed or traveling conveyance structure adapted to support a water delivery system associated with a plurality of sprinkler assemblies to distribute water over ground,

b. mixing valves associated with each sprinkler assembly and the water delivery system structured to mix acidified water with the water delivered to the sprinkler assemblies from the water delivery system,

c. a water source operably associated with the water delivery system,

d. means to divert a portion of the water source,

e. a sulfurous acid generator adapted to acidify the diverted portion of the water source creating sulfurous acid,

f. a manifold affixed to the conveyance structure adapted to receive sulfurous acid from the sulfurous acid generator and operably associated with each mixing valve to blend sulfurous acid with the water from the water delivery system as it passes through each sprinkler assembly to distribute acidified water over the ground.

Preferably the mixing valves are adjustable to meter different amounts of acid and water through each sprinkler to compensate for differing flow pressures; thereby insuring that approximately the same amount of acidified water is uniformly delivered over the ground. Thus, ground at the end of the conveyance structure receives the same amount of acidified water as that near the beginning of the conveyance structure.

In wheel lines, pivots, and other traveling conveyance structure, the water delivery system is usually a water conduit paralleling the conveyance structure. Affixed parallel to the water delivery system is an acid manifold, generally structured as an acid conduit. The water conduit and acid conduits are connected to mixing valves to blend and pass acidified water through the sprinklers so that the acid does not contact the water delivery system and conveyance system causing corrosion. Thus, only the mixing valve, sprinklers, and manifold need to be made of acid resistant materials.

The invention is readily adapted as a kit to modify existing sprinkler water delivery systems having sprinkler assemblies. The kit includes an acid manifold affixed to the conveyance structure, which is adapted to receive and deliver sulfurous acid. In addition, the kit includes mixing valves associated with each sprinkler assembly. The mixing valves are in communication with the water delivery system, and the acid manifold to mix acidified water with irrigation water for delivery through the sprinkler assemblies. Lastly, sulfurous acid generator means are included for producing and delivering sulfurous acid to the acid manifold for distribution through the mixing valves and sprinkler assemblies to co-mix with the irrigation water for land application at a pH level that will not damage the sprinkler assemblies.

Other necessary adaptive couplings, such as a center pivot swivel may be included in the kit to adapt conventional water delivery systems to blend and deliver sulfurous acid from the sulfurous acid generator through their sprinkler assemblies. Metering valves to meter the amount of acid for admixing with the irrigation water may also be included in the kit to adjust and deliver the desired acid composition.

These kit components enable conventional irrigation water delivery systems to be adapted to introduce varying concentrations of sulfurous acid solutions to remove alkalinity from irrigation water and condition soils.

The invention thus provides a method and apparatus for irrigation water acidification delivery.

### DESCRIPTION OF THE DRAWINGS

FIG. 1 is a perspective view of the invention.

FIG. 2 is a front view of an adjusting metering valve.

FIG. 3 is a side view of the adjusting metering valve shown in FIG. 2.

FIG. 4 is a perspective view of a center pivot swivel with inside electrical conduit.

FIG. 5 is a side view of a center pivot swivel of FIG. 4.

FIG. 6 is a perspective view of a center pivot swivel with outside electrical conduit.

### DESCRIPTION OF THE ILLUSTRATED EMBODIMENTS

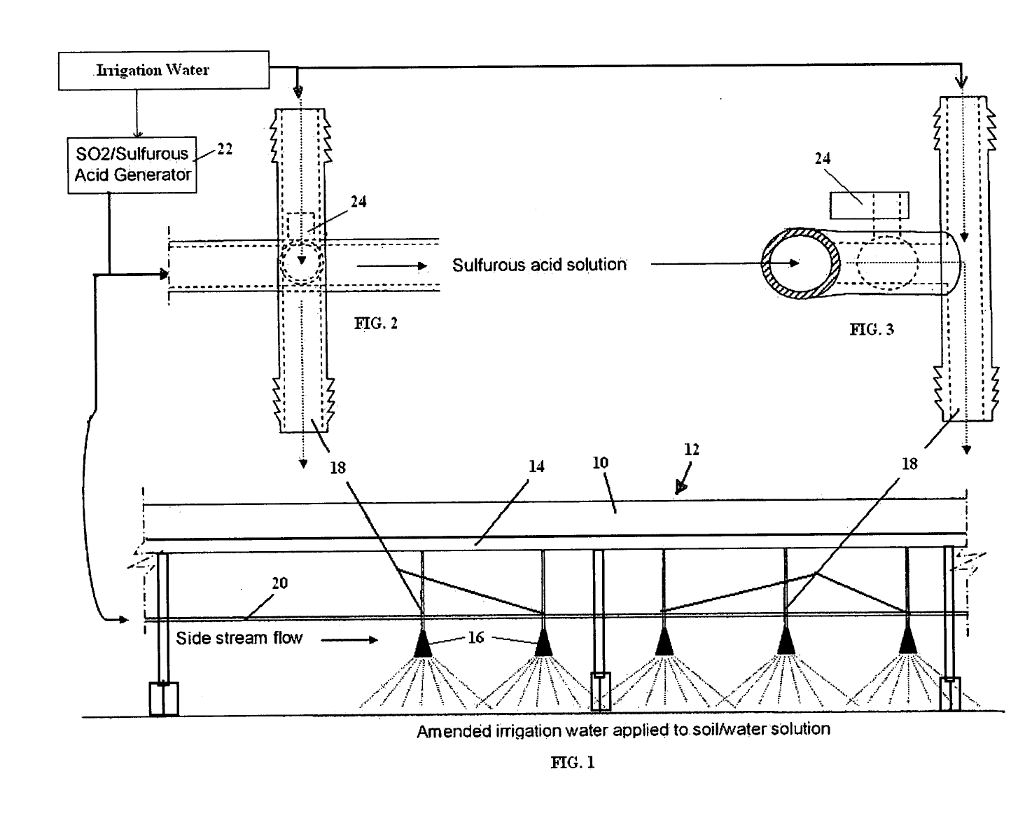

FIG. 1 is a perspective view of an embodiment of the invention showing how the arm 10 of a traveling pivot irrigation water delivery system 12 is adapted. The invention comprises a fixed or traveling water delivery system 12 with an irrigation water delivery conduit 14 associated with a plurality of sprinkler assemblies 16 to distribute water over ground.

Mixing valves 18 are associated with each sprinkler assembly 16 and the water delivery conduit 14 to mix acidified water from an acid manifold 20 with the water delivered to the sprinkler assemblies 16 from the water delivery conduit 14.

The water delivery conduit 14 is operably associated with the mixing valves 18. A diverter (not shown) diverts a portion of the irrigation water source to a sulfurous acid generator 22 adapted to acidify the diverted portion of the water source creating sulfurous acid entering the acid manifold 20.

The acid manifold 20 is affixed to the arm 10 of the irrigation water delivery system 12 to receive the sulfurous acid from the sulfurous acid generator 22. The acid manifold 20 is operably associated with each mixing valve 18 as shown to blend sulfurous acid with the irrigation water from the water delivery conduit 14 as it passes through each sprinkler assembly 16 to distribute acidified water over the ground.

Preferably the mixing valves 18, more particularly shown in FIGS. 2, 3, are adjustable with an adjustable metering valve device 24 to meter different amounts of acid and water through each sprinkler assembly 16 to compensate for differing flow pressures; thereby insuring that approximately the same amount of acidified water is uniformly delivered over the ground. Thus, ground at the end of the water delivery system 12 receives the same amount of acidified water as that near the beginning of the water delivery system 12.

In wheel lines, pivots, and other traveling water delivery systems 12, the water delivery conduit 14 parallels the arm 10 of the water delivery system 12. Affixed parallel to the water conduit 14 is another acid conduit 20. The water conduit 14 and acid conduit 20 are connected to the mixing valves 18 to blend and pass acidified water through the sprinkler assemblies 16 so that the acid does not contact the water delivery system 14 and water delivery system 12 causing corrosion. Thus, only the mixing valves 18, sprinkler assemblies 16, and acid manifold 20 need to be made of acid resistant materials.

The invention is readily adapted as a kit to modify existing sprinkler water delivery systems for applying acidified irrigation water to a field of ground via an existing water delivery system 12 supporting a plurality of independently operable sprinkler assemblies 16. The kit includes an acid manifold 20 affixed to the structure of the water delivery system 12 structured to receive and deliver sulfurous acid. In addition, the kit includes mixing valves 24 associated with each sprinkler assembly 16. These mixing valves 24 are in communication with the water delivery system 14, and the acid manifold 20 to mix acidified water with irrigation water for delivery through the sprinkler assemblies 16. Lastly, means, such as a sulfurous acid generator 22, are included for producing and delivering sulfurous acid to the acid manifold 20 for distribution through the mixing valves 24 and sprinkler assemblies 16. There the sulfurous acid is co-mixed with the irrigation water for land application at a pH level that will not damage the sprinkler assemblies.

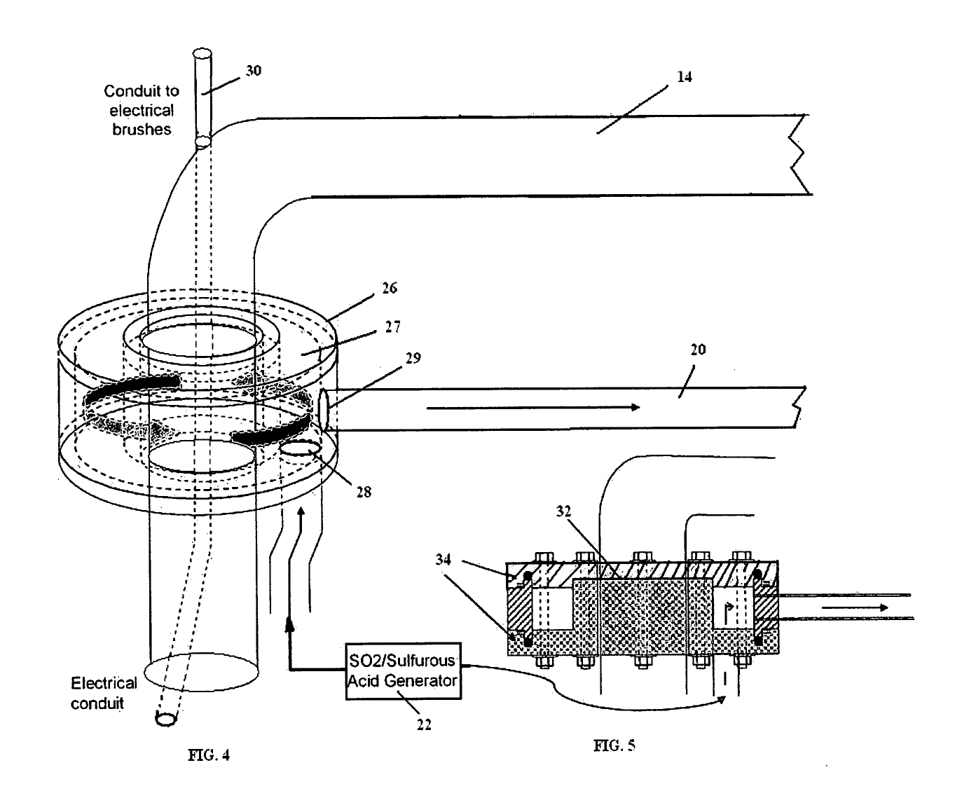

In addition, couplings, such as a center pivot swivel 26 with an interior reservoir 27 having an inlet 28, and an outlet 29 in communication with the acid manifold 20 shown in FIG. 4, are included. FIG. 4 is a perspective view of a center pivot swivel 26 used for adapting an irrigation pivot with a water conduit 14. An inside electrical conduit 30 passes through the water delivery system water conduit 14, as shown. The center pivot swivel 26 outlet 29 is in communication with the acid manifold 20 to deliver sulfurous acid generated by the SO2/Sulfurous Acid Generator 22.

FIG. 5 is a side view of the center pivot swivel 26, illustrating how a Teflon gasket 32 and roller bearing and O ring seals 34 are included to prevent the center pivot swivel 26 from leaking during operation.

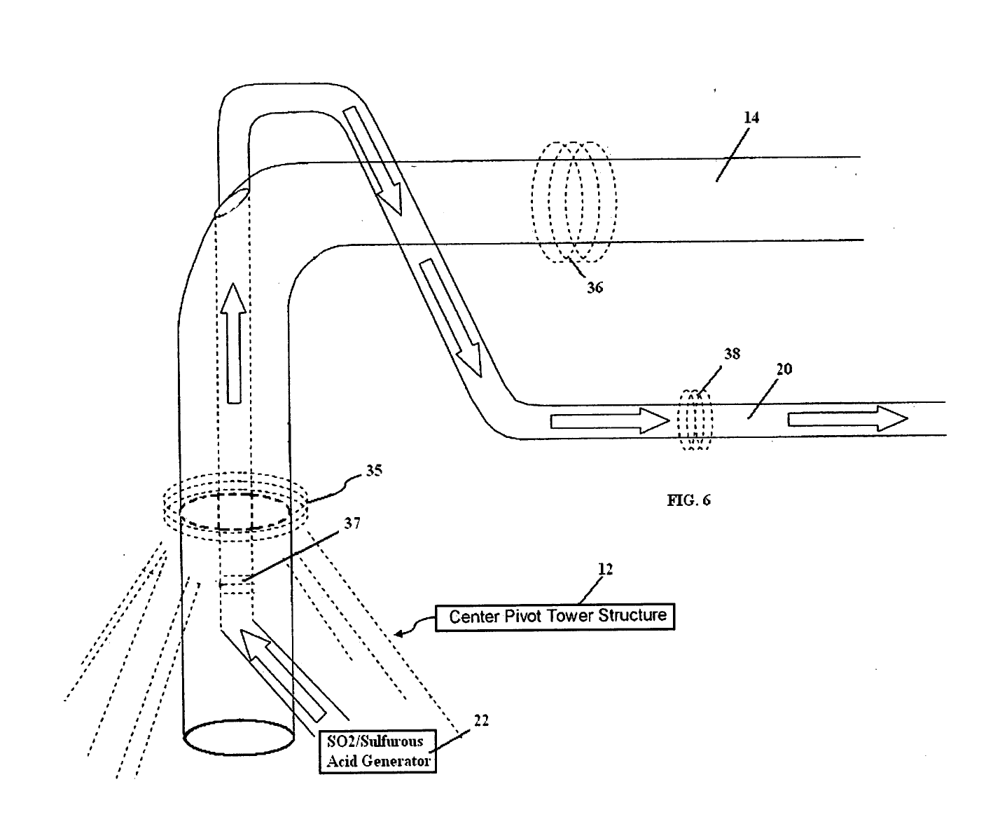

FIG. 6 is a side view of another center pivot swivel 35 for center pivot systems with outside electrical brushes used in association with center pivot tower structure 12. Connecting unions 36, 37, 38 are associated with the water conduit 14 and acid manifold 20 as shown. The electrical conduit (not shown) is mounted externally to the center pivot tower structure.

The acid manifold 20, mixing valves 24, and sprinkler assemblies 16 are made of acid and ultra-violet light resistant materials fitted to introduce sulfurous acid at a controlled and metered feed rate that can be set manually using a plastic ball, gate, or flange style valve 24; fixed orifice flow control devices (not shown); and/or varied through the use of electronic solenoid valve fittings, etc. (not shown). The metered sulfurous acid is thus injected into any side or down stream flow of irrigation water through the irrigation conveyance structure 12.

The invention thus provides an alternative way to introduce acidity into irrigation water and soil/water solution by diverting and feeding a side stream through a sulfurous acid generator 22 forming a sulfurous acid solution, which is then introduced into mixing valves 24 associated with sprinkler assemblies 16 to co-mix with irrigation water for land application. The invention 10 thus enables machine operators to avoid over-acidification problems by introducing metered concentrated solution of sulfurous acid downstream completely avoiding the need to acidify the main body of water flowing through an irrigation water structure.

Although this specification has referred to the illustrated embodiments, it is not intended to restrict the scope of the appended claims. The claims themselves recite those feature deemed essential to the invention.

I claim:

1. An apparatus for acidifying and applying irrigation water to a field of ground to be irrigated comprising:
a. a fixed or traveling conveyance structure with
i. a water delivery system and
ii. a plurality of independently operable sprinkler assemblies affixed to the conveyance structure oriented in a fixed array relative to each other, with each of said sprinkler assemblies being operable to distribute an amount of irrigation water from the water delivery system over a zone of ground,
b. mixing valves associated with each sprinkler assembly and the water delivery system to mix acidified water with water delivered to the sprinkler assemblies from the water delivery system,
c. an irrigation water source operably associated with the water delivery system,
d. a source of sulfurous acid, and
e. a manifold affixed to the conveyance structure adapted to receive the sulfurous acid and deliver to each mixing valve sulfurous acid for blending with the water from the water delivery system as it passes through each sprinkler assembly to distribute co-mixed acidified water over the ground.

2. An apparatus according to claim 1, wherein the source of sulfurous acid comprises a diverter associated with the irrigation water source to divert a portion of the irrigation water through a sulfurous acid generator adapted to acidify the diverted portion of the irrigation water source to generate sulfurous acid.

3. A kit for adapting an apparatus for applying acidified irrigation water to a field of ground to be irrigated having conveyance structure supporting a plurality of independently operable sprinkler assemblies oriented in a fixed array relative to each other, with each of said sprinkler assemblies being operable to distribute an amount of irrigation water over a zone of ground; means for delivering irrigation water to each of the sprinkler assemblies in the fixed array; and a mover for moving the fixed array of sprinkler assemblies over the ground; comprising:
a. a manifold affixed to the conveyance structure adapted to receive and deliver sulfurous acid,
b. mixing valves associated with each sprinkler assembly, the water delivery system, and the manifold to mix acidified water with irrigation water delivered to the sprinkler assemblies from the water delivery system, and
c. means for producing and delivering sulfurous acid to the manifold, mixing valves, and sprinkler assemblies to co-mix with irrigation water for land application at a pH level that will not damage the sprinkler assemblies.

4. A kit according to claim 3, wherein the mixing valves are adjustable to meter different amounts of acid and water through each sprinkler to compensate for differing flow pressures; thereby insuring that approximately the same amount of acidified water is uniformly delivered over the ground.

5. A kit according to claim 3, wherein the means for producing and delivering sulfurous acid to the manifold comprises a sulfurous acid generator adapted to acidify a portion of the irrigation water source to generate sulfurous acid for passage through each mixing valve for blending with the irrigation water as it passes through each sprinkler assembly to distribute co-mixed acidified water over the ground.

6. A kit according to claim 3, including control means operatively connected to the plurality of sprinkler assemblies for controlling the distribution of water over the zones of ground and variably adjusting the amount of water applied within the zones.

7. A kit according to claim 3, including a plurality of electrically operable shutoff valves for selectively allowing passage of water from the means for delivering water to each of the sprinkler assemblies, each valve being operatively interconnected between said means for delivering water and a sprinkler assembly; and means for electrically connecting each of said shutoff valves to the control means, for selective operation of said shutoff valves.

8. A method for acidifying and applying irrigation water to a field of ground to be irrigated comprising:
a. affixing a manifold to a fixed or traveling conveyance structure with
i. a water delivery system and
ii. a plurality of independently operable sprinkler assemblies affixed to the conveyance structure oriented in a fixed array relative to each other, with each of said sprinkler assemblies being operable to distribute an amount of irrigation water from the water delivery system over a zone of ground; the manifold adapted to receive and deliver sulfurous acid,
b. attaching mixing valves to each sprinkler assembly, the water delivery system and the manifold to mix acidified water with the water delivered to the sprinkler assemblies from the water delivery system,
c. operably associating irrigation water source with the water delivery system,
d. generating a source of sulfurous acid, and
e. passing sulfurous acid through the manifold to deliver to each mixing valve sulfurous acid for blending with the water from the water delivery system as it passes through each sprinkler assembly to distribute co-mixed acidified water over the ground.
